(19) United States
(12) Patent Application Publication
(10) Pub. No.: US 2016/0123175 A1
(43) Pub. Date: May 5, 2016

(54) HYBRID MODEL BASED DETECTION OF COMPRESSOR STALL

(71) Applicant: General Electric Company, Schenectady, NY (US)

(72) Inventor: Maria Cecilia Mazzaro, Greenville, SC (US)

(21) Appl. No.: 14/534,028

(22) Filed: Nov. 5, 2014

(51) Int. Cl. F01D 17/02; G01M 15/14

(52) U.S. Cl. CPC F01D 17/02; G01M 15/14; F05D 2270/101

(57) ABSTRACT

Systems, tangible non-transitory machine readable computer media, and methods are provided. In one embodiment a system includes an industrial controller having at least one processor configured to: receive a measured input from a turbomachinery having a compressor, execute a hybrid model of the compressor, receive a measured output, compare the measured input to the measured output to derive an error value, perform a signature analysis if the error value is beyond a range; and derive a probability of compressor stall based on the signature analysis.

### BACKGROUND OF THE INVENTION

The subject matter disclosed herein relates to systems and methods related to risk modeling, more specifically, to risk modeling of turbomachinery systems.

Machine systems, including turbomachine systems, may include a variety of components and subsystems participating in a process. For example, a turbomachine may include compressors, fuel lines, combustors, a turbine system, exhaust systems, and so forth, participating in the generation of power. The components and subsystems may additionally include systems suitable for monitoring the process, and determining if the process is operating within certain limits, which may allow the system to predict or prevent certain phenomena, such as compressor stall. However, machine systems may be complex, including numerous interrelated components and subsystems. Accordingly, recognizing or predicting a reliability or risk of operations of complex systems may be difficult and time-consuming.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes an industrial controller having at least one processor configured to: receive a measured input from a turbomachinery having a compressor, execute a hybrid model of the compressor, receive a measured output, compare the measured input to the measured output to derive an error value, perform a signature analysis if the error value is beyond a range; and derive a probability of compressor stall based on the signature analysis.

In a second embodiment, tangible non-transitory machine readable computer media comprising computer instructions are provided. The instructions are configured to receive a measured input, execute a hybrid model, receive a measured output, compare the measured input to the measured output to derive an error value, perform a signature analysis if the error value is beyond a range, and derive a probability of compressor stall based on the signature analysis.

In a third embodiment, a method includes receiving a measured input based on compressor operations, executing a hybrid model, receiving a measured result of compressor operations, comparing the measured input to the measured result to derive an error value, performing a signature analysis if the error value is beyond a range, and deriving a probability of compressor stall based on the signature analysis, wherein the hybrid model comprises a physics-based model and a statistical model.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of turbomachinery, such as a gas turbine system, that may experience compressor stall;

FIG. 2 is a two-dimensional chart representing an embodiment of a compressor stall;

FIG. 3 is a flowchart of an embodiment of an process suitable for predicting and/or detecting compressor stall; and

FIG. 4 is a block diagram of an embodiment of a system for predicting and/or detecting compressor stall.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

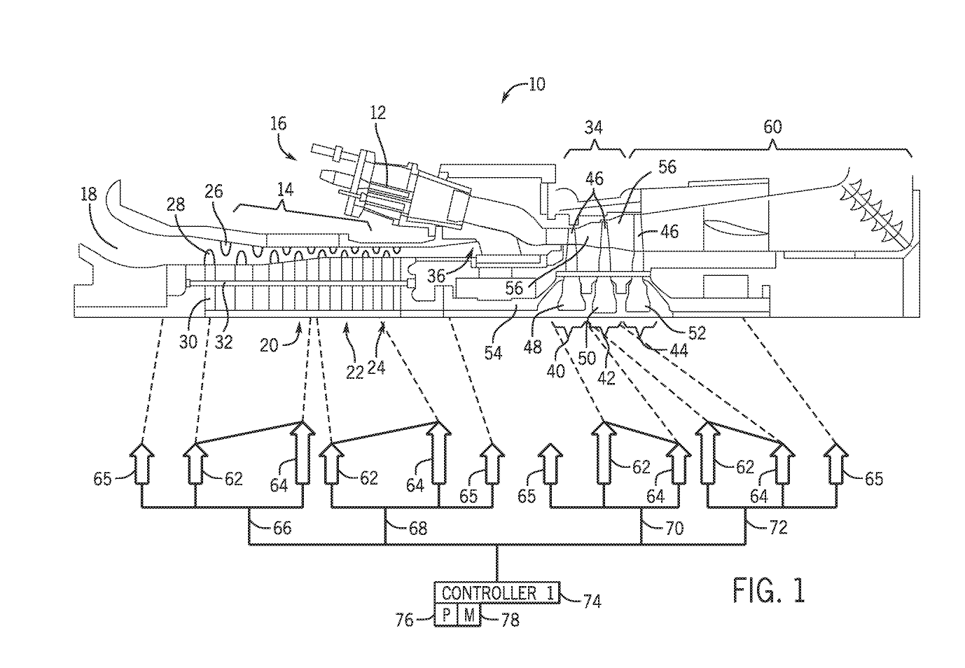

The disclosed embodiments include systems and methods for predicting and preventing machine conditions such as compressor stall in a turbine system. More specifically, the disclosed embodiments include the creation of hybrid risk models suitable for predicting compressor stall, and for certain measures that may be taken to eliminate compressor stall. The models integrate physics-based analysis or physics-based models with a statistical analysis or statistics-based models of empirical data observed during the real world usage of mechanical machinery, such as the turbine system described in more detail with respect to FIG. 1 below. The hybrid risk models also enable the unit level prediction of compressor stall. That is, a fleet of turbine systems, such as a fleet of MS-7000F turbine systems, a fleet of MS-7000FA turbine system, and/or a fleet of MS-9000F turbine systems, available from General Electric Co. of Schenectady, N.Y., may be operationally managed at the individual turbine level for compressor stall, thus allowing for the individual management of substantially all of the turbine installations in the fleet. Additionally, the embodiments described herein, allow for the sharing of data, models, calculations, and/or processes across the turbine fleet, thus enabling a multi-level operational management (e.g., unit level and fleet level) of the turbine fleet, for example, of compressor stall precursors and conditions.

There are several types of compressor stall, including rotating stall (e.g., incipient surge, stagnation, etc.) and axi-symmetric stall (e.g., compressor surge). Rotating stall may occur when localized regions of separated air flow move along a diffuser section at speeds below the rotational speed of the compressor blades. Compressor surge may be indicated by a rise in exhaust temperature and/or a rise in compressor speed. If the stall or surge remains undetected and is permitted to continue, it may cause undesired behavior in a gas turbine engine. It would be beneficial to use a hybrid model, such as a model utilizing both statistical and physical models, to enable earlier detection and/or prevention of compressor stall.

Statistical analysis may be used, for example, to attempt to predict the outage risk of a turbine component based on historical data, such as compressor stall data. However, such statistical analysis may not be as accurate, especially when applied to predictions for a specific unit. Physics-based analysis of components may also be used in an attempt to predict equipment outages. Such physics-based analysis may create models that include virtual representations of the physical components. The virtual representations may then be used, for example, to simulate “wear and tear” of the components. However, such physics-based analysis alone may not realize a desired level of predictive accuracy. The embodiments disclosed herein allow for the derivation of hybrid risk models that integrate certain statistical analysis with physics-based analysis. The hybrid risk models may result in improved predictive accuracy. Indeed, the disclosed embodiments may allow for a much improved level of predictive accuracy over the entire lifespan of individual turbine installations or other turbomachinery.

In certain embodiments, the behavior of a specific turbine system may be observed during the operational life of the system, and such observations may be used to predict unwanted maintenance events, such as the occurrence of stall or surge conditions, that may require unplanned maintenance and/or incur additional costs. Indeed, the disclosed embodiments improve the operational life of mechanical systems by analyzing data from such systems, determining the likelihood of unplanned maintenance events, and recommending the replacement of certain parts so as to minimize or substantially eliminate unplanned disruptions of system operations. Accordingly, a much improved maintenance schedule and asset management of systems in a turbine fleet, may be realized. Indeed, the operational life of the analyzed turbo machinery may be improved while minimizing or eliminating the occurrence of certain unplanned maintenance events, such as compressor stall or surge related events.

It may be beneficial to first discuss embodiments of certain mechanical systems that may be used with the disclosed embodiments. With the foregoing in mind and turning now to FIG. 1, the figure illustrates a cross-sectional side-view of an embodiment of a turbine system or gas turbine engine 10. Mechanical systems, such as the turbine system 10, experience mechanical and thermal stresses during operating conditions that may require periodic maintenance or replacement. During operations of the turbine system 10, a fuel such as natural gas or syngas, may be routed to the turbine system 10 through one or more fuel nozzles 12 into a combustor 16. Air may enter the turbine system 10 through an air intake section 18 and may be compressed by a compressor 14. The compressor 14 may include a series of stages 20, 22, and 24 that compress the air. Stage 20 may be a high pressure stage, stage 22 may be an intermediate pressure stage, and stage 24 may be a low pressure stage. Each stage may include one or more sets of stationary vanes 26 and blades 28 that rotate to progressively increase the pressure to provide compressed air. The blades 28 may be attached to rotating wheels 30 connected to a shaft 32. The compressed discharge air from the compressor 14 may exit the compressor 14 through a diffuser section 36 and may be directed into the combustor 16 to mix with the fuel. For example, the fuel nozzles 12 may inject a fuel-air mixture into the combustor 16 in a suitable ratio for optimal combustion, emissions, fuel consumption, and power output. In certain embodiments, the turbine system 10 may include multiple combustors 16 disposed in an annular arrangement. Each combustor 16 may direct hot combustion gases into a turbine 34.

As depicted, the turbine 34 includes three separate stages 40, 42, and 44. The stage 40 may be a high pressure stage, stage 42 may be an intermediate pressure stage, and stage 44 may be a low pressure stage. Each stage 40, 42, and 44 includes a set of blades or buckets 46 coupled to a respective rotor wheel 48, 50, and 52, which are attached to a shaft 54. As the hot combustion gases cause rotation of turbine blades 46, the shaft 54 rotates to drive the compressor 14 and any other suitable load, such as an electrical generator. Eventually, the turbine system 10 diffuses and exhausts the combustion gases through an exhaust section 60.

The turbine system may also include a plurality of sensors configured to monitor a plurality of engineering parameters related to the operation and performance of the gas turbine engine 10. The sensors may include, for example, inlet sensors 62 and outlet sensors 64 positioned adjacent to, for example, the inlet and outlet portions of the turbine 16, the various stages (e.g., 20, 22, and/or 24) of the compressor 14. The inlet sensors 62 and outlet sensors 64 may measure, for example, environmental conditions, such as ambient temperature and ambient pressure, as well as a plurality of engine parameters related to the operation and performance of the turbine system 10, such as, exhaust gas temperature, rotor speed, engine temperature, engine pressure, gas temperature, engine fuel flow, exhaust flow, vibration, clearance between rotating and stationary components, compressor discharge pressure, pollution (e.g., particulate count), and turbine exhaust pressure. Further, the sensors 62 and 64 may also measure actuator 65 information such as valve position, and a geometry position of variable geometry components (e.g., air inlet). The plurality of sensors 62 and 64 may also be configured to monitor engine parameters related to various operational phases of the turbine system 10. Measurements taken by the plurality of sensors 62 and 64 may be transmitted via module lines 66, 68, 70, and 72, which may be communicatively coupled to a controller. For example, module line 66 may be utilized to transmit measurements from the high pressure stage 24 of the compressor 14, while module line 68 may be utilized to transmit measurements from the intermediate pressure stage 22 of the compressor 14. In a similar manner, module line 70 may be utilized to transmit measurements from the high pressure stage 40 turbine 34, while module line 72 may be utilized to transmit measurements from the intermediate pressure stage 42 of the turbine 34. Additionally, module lines 66, 68, 70, and 72 may be used to transmit signals suitable for actuating the actuators 65. The actuators 65 may include valves, inlet guide vanes, pumps, and the like, useful in controlling the system 10. Thus, module lines 66, 68, 70, and 72 may transmit measurements from separate modules of the turbine system 10 to the controller 74, and may transmit signals from the controller 74 to the actuators 65 for use in controlling the system 10. The controller 74 may include a processor 76 useful in executing computer code or instructions, and memory 78 useful in storing the computer code or instructions.

As discussed in further detail below, the disclosed embodiments include the creation of one or more models, such as hybrid risk models, suitable for capturing the physics of the parameters being analyzed (e.g., pressure, temperature, flow rate, flow mass, etc.) and integrating the physics-based models with statistical analysis. Such a unit-level hybrid risk model may be used, for example, to predict the risk of compressor 14 stall for a specific turbine system 10 in the fleet. Accordingly, the hybrid risk model may enable a larger stall detection lead time, and smaller false positive and negative detection rates. Further, the hybrid risk model may be used to optimize operations for each or for all turbine units 10 in the fleet. For example, a more efficient maintenance and downtime schedule may be arrived at by using the predictive embodiments described herein.

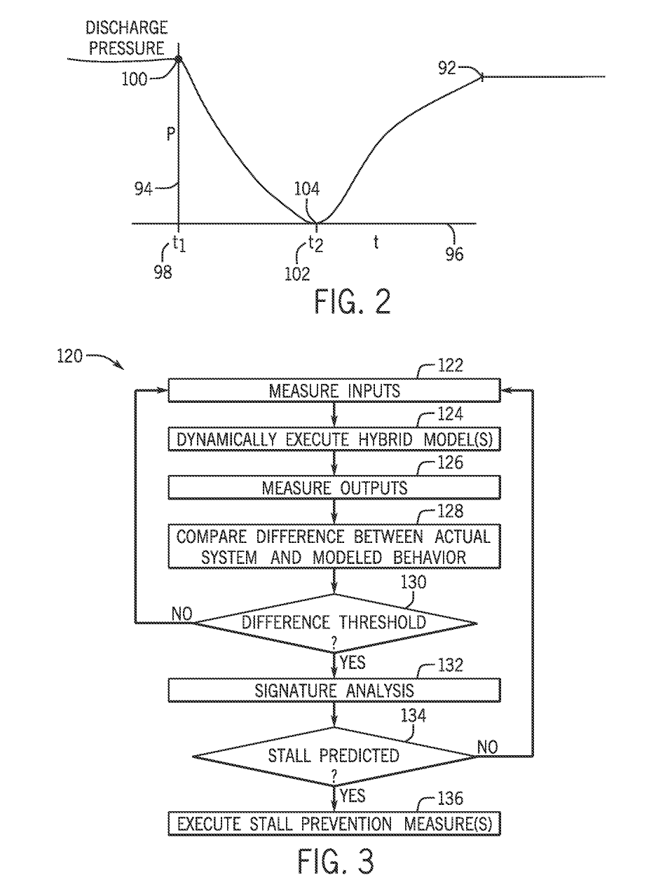

FIG. 2 is a graphical chart of an embodiment of an occurrence of compressor stall. Curve 92 depicts in two dimensions a compressor stall occurring, for example, in the compressor 14. The curve 92 is a magnitude of pressure curve, as indicated by pressure axis 94 over time 96. Curve 92 shows that compressor stall may begin at a first time 98, when the pressure of the compressor 14 begins to fall from a baseline discharge pressure 100. This may occur when one or more compressor 14 stages (e.g., the high pressure stage 40, the intermediate pressure stage 42, and/or the low pressure stage 44) is not having a desired smooth air flow to the succeeding stage(s). The decrease in pressure may indicate that air flow through the compressor 14 has decreased, causing a head capability (e.g., work required to isentropically compress a gas from the inlet total pressure and total temperature to the discharge total pressure) of the compressor 14 to also decrease. As the head capability decreases, flow further decreases. Once the flow has decreased to a level such that the compressor 14 can no longer meet the external head, such as at a second time 102, the pressure reaches a minimum 104, which may be significantly lower than the discharge pressure 100. In some situations, the minimum 104 may approach zero, or it may be a negative pressure.

A rise in pressure after the pressure reaches the minimum 104 may indicate that that the air flow has reversed directions, and this flow reversal may induce one or more thermodynamic phenomena. For example, the temperature of the compressor 14 changes with the pressure (e.g., the temperature decreases as the pressure decreases, and the temperature increases as the pressure increases). Thermodynamic phenomena such as these are detectable through pressure and flow derivatives and from measured mechanical parameters, such as axial displacement and speed instability. Cross-checking between these thermodynamic and mechanical parameters using the hybrid model disclosed herein may lead to more reliable stall and surge detection in the gas turbine engine 10. The disclosed hybrid model may normalize the effect of input variations (e.g., from unit 10 to unit 10 variations, input noise, etc.), combine information from multiple sensors (e.g., sensors 62 and 64), increase a signal to noise ratio, and may otherwise increase the quality of the stall prediction and detection.

FIG. 3 is a flow chart depicting an embodiment of a process 120 which may be executed by the controller 74 to model and manage assets of the turbine system 10, such as the compressor 14, in order to predict or detect compressor stall such as that described in FIG. 2. It is to be understood that the process 120 and the techniques disclosed herein may be used with any turbomachinery, such as turbines, compressors 14, and/or pumps. Turbines may include gas turbines 10, steam turbines, wind turbines, hydro turbines, etc. Furthermore, the process 120 may be implemented as executable code or instructions stored in a non-transitory machine readable medium, such as the memory 78 of the controller 74, and may be executed by the processor 76, for example, to transform data, such as sensor data, into hybrid risk models, model outputs and derivations. Additionally, any of the models and sub models described herein, may be stored in the memory 78 of controller 74 and used to control, for example, operational and maintenance activities related to the gas turbine engine 10 and the assets of the gas turbine engine 10.

Accordingly, a variety of sensed inputs from the gas turbine engine 10 may be measured in real time, as indicated by step 122. Measured inputs may include compressor 14 discharge pressure and temperature, compressor 14 suction pressure, compressor 14 axial displacement, compressor 14 speed, throttle mass flow, ambient conditions (e.g., ambient temperature, altitude), radial vibrations, clearance (e.g., distance between rotating and stationary components) and/or other inputs. The measured inputs may also include data transmitted, for example, by inlet and outlet sensors 62 and 64 at a number of locations and systems on the turbine 10, such as on fuel nozzles 12, compressor 14, combustor 16, turbine 34, and/or exhaust section 60. Next, the measured inputs may be used to dynamically execute hybrid models, as indicated at step 124, which may run simulations of the compressor 14 and/or other gas turbine engine 10 components in real time (e.g., as the compressor 14 is operating).

The hybrid model may include a physics-based model, a statistical model, an artificial intelligence (AI) model, or a combination thereof, and the hybrid model may analyze the measured inputs to predict the outputs of the compressor 14. A variety of modeling techniques may be used in the hybrid model, including thermal fluid dynamics techniques, which may result in numerical and physical modeling of the gas turbine engine 10 and turbine 10 components. The hybrid model may be derived by modeling mechanical components (e.g., compressor blades, intake design, outlet design, etc.) through physics-based modeling techniques, such as low cycle fatigue (LCF) life prediction modeling, computational fluid dynamics (CFD), finite element analysis (FEA), solid modeling (e.g., parametric and non-parametric modeling), and/or 2-dimension to 3-dimension FEA mapping. Indeed, any number and variety of modeling techniques may be used, which may result in numerical and physical modeling of the gas turbine engine 10 and related components.

The hybrid models may operate at different levels of the gas turbine engine 10. For example, the hybrid model may enable predictive abilities for the turbine system 10 as a whole, or for a turbine system component such as a rotor, or the compressor 14. The hybrid risk model can also operate across locations of a system such as the gas turbine engine 10. Example locations used for predictive results may include the air intake section 18, the compressor sections 40, 42, and 44, the rotor sections, and the exhaust section 60. Indeed, any location or section of the turbine system 10 may be used.

Sensors may then measure outputs of the compressor 14, as indicated by step 126, which may include the same or different parameters as the inputs measured in step 122. For example, measured outputs may include downstream pressure, compressor speed, mass flow, etc. As represented by step 128, the logic 120 may then compare the difference between the actual system behavior (e.g., the measured outputs) and the behavior predicted by the hybrid model. The outputs measured from step 126 may be used to calibrate the hybrid model, for example by correcting the estimates and predictions of the hybrid model. Next, the deviation, or error value, between the actual system behavior and modeled behavior may be analyzed, and the logic may determine whether the deviation is greater than or less than a difference range or threshold, as shown in step 130. The difference threshold may be a pre-determined or assigned value or difference that may be used for multiple turbines 10, or it may be configured specifically for each gas turbine engine 10. If the deviation determined in step 128 by comparing the difference between actual system and modeled behavior is found to be less than the threshold value, the logic 120 may continue to measure inputs of the compressor 14.

However, if the deviation or error is found to be greater than the difference threshold (decision 130), the system may run a signature analysis, represented by step 132. The signature analysis may use any number of analyzing methods to determine a signature (e.g., linear or nonlinear regression, data mining [k-means clustering, Bayesian classification, maximum likelihood estimation], neural network training, expert system rules), which may be a frequency curve or a combination of signals (e.g., frequency, temperature, flow rate, radial vibrations, etc.) that create a vector (e.g., the signature). By defining an expected signature (e.g., expected changes in thermodynamic and mechanical parameters as a result of incipient stall and stall events) it is possible to fuse statistical change detection algorithms, which may be purely data driven, with model based detection algorithms to predict stall, as shown in step 134. If stall is predicted (decision 134), the logic 120 may execute stall prevention measures, shown in step 136, which may include repositioning an inlet guide vane, opening a valve to release pressure, driving an actuator, or other measures. If stall is not predicted in step 134, then the logic 120 returns to step 122 and measures inputs once more. Accordingly, the process 120 may predict (decision 134) with improved accuracy, and may then provide for desired stall prevention measures (block 136).

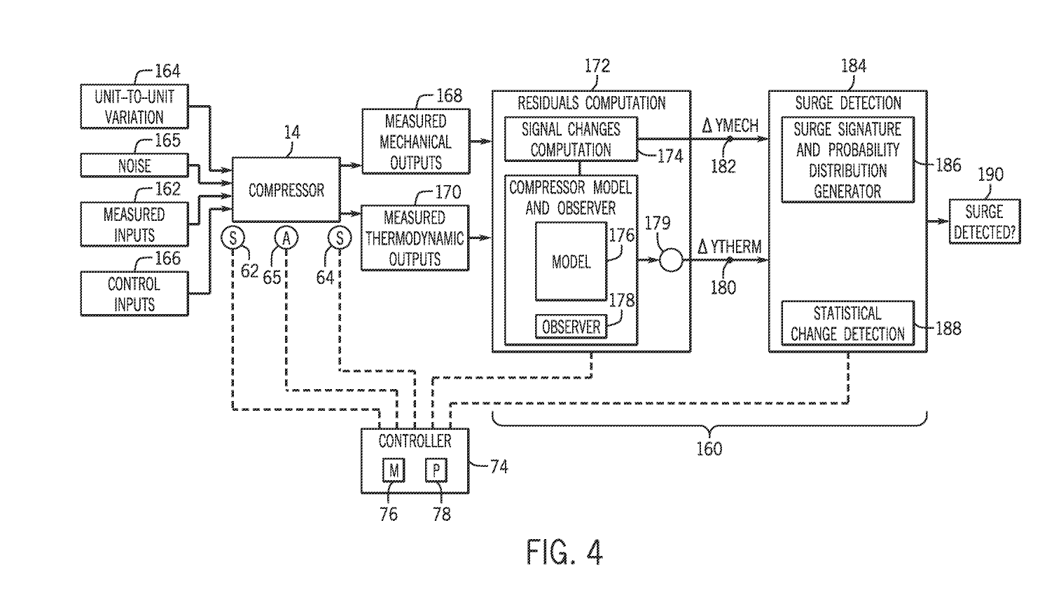

FIG. 4 is a block diagram illustrating an embodiment of a system 160 suitable for predicting and acting upon stall in the compressor 14. The system 160 may be provided as a software system stored in the memory 76 of the controller 74 and executable by the processor 78, as a hardware system (e.g., circuitry in the controller 74, or a hardware card insertable into the controller 74), or a combination thereof. As illustrated, sensors 62 measure input parameters of the compressor 14 to deliver a number of measured inputs 162 or signals representative of the measure inputs 162 to be used by the system 160. The measured inputs 162 may include mechanical data (e.g., engine fuel flow, rotor speed, exhaust flow, vibration, axial displacement, clearance between rotating and stationary components, flow rates, fuel type), and thermodynamic data (e.g., exhaust gas temperature, engine temperature, engine pressure, compressor discharge pressure, suction pressure, turbine exhaust pressure, gas temperature).

The sensors 62 may monitor and/or record (block 164) unit-to-unit variation (e.g., data variations between compressors 14 disposed in the same turbine 10 or between compressors 14 disposed in a fleet of turbines 10) and input noise (e.g., sensor signal noise) 165. One or more control inputs 166, such as signals transmitted via the controller 74 useful in controlling compressor behavior, such as compressor flow rate, speed, pressure, temperature, and the like, may be used by the actuators 65 to control the compressor 14, and may also be provided to the system 160. The output sensors 64 may measure mechanical outputs 168 and thermodynamic outputs 170 of the compressor 14, which may be similar to or different from the measured input parameters. The data regarding the inputs and outputs of the compressor 14 may then be processed, as shown by the residuals computation system 172. The residuals computation system 172 may derive signal changes computations 174, as well as computations performed by the hybrid model 176 and the compressor observer 178 to predict thermodynamic outputs (e.g., using the measured inputs 162, unit-to-unit variation and input noise 164, control inputs 166, and the measured mechanical and thermodynamic outputs 168 and 170). In one embodiment, the signal changes computation 174 may be calculated using the time difference equation y(n)=x(n)−x(n−T) where T is time. The hybrid model 176 may include a Moore-Greitzer compressor model, a Fink compressor model, a Botros compressor model, or a combination thereof, to predict thermodynamic outputs.

The compressor observer 178 may also predict thermodynamic outputs. For example, the compressor observer 178 may include a thermodynamic model of a compressor 14 operating normally, and it may continuously track compressor dynamical states (e.g., downstream pressure, speed, mass flow, etc.). The deviation between measured and predicted thermodynamic parameters may then be used to detect incipient stall and surge of the compressor 14. The measured inputs 162 from the inlet sensors 62 are transmitted to the compressor observer 178, which processes the measured inputs 162 to predict the thermodynamic outputs of the compressor 14. In the current embodiment, the compressor observer 178 may be included in the controller 74; however, in other embodiments, the compressor observer 178 may be part of an embedded system, a computer, or multiple controllers 74.

In addition to the measured inputs 162, the compressor observer 178 may receive the plurality of control inputs 166 (e.g., throttle mass flow) and environmental conditions (e.g., ambient temperature, pressure, etc.), and unit-to-unit variation and input noise 164. Signal processing techniques, such as frequency domain analysis (Fourier series, fast Fourier transform (FFT), and mixed time-frequency analysis (wavelet transform), may be used by the compressor observer 178 to analyze the received inputs (e.g., the measured inputs 162 and the control inputs 166). The compressor observer 178 may also use optimal linear filtering (e.g., Kalman filtering and extended filtering) and/or statistical signal detection (e.g., matched filters useful in correlating a known signal, or template, with an unknown signal to detect the presence of the known signal or template in the unknown signal, for example, a North filter). In one presently contemplated embodiment, the compressor observer 178 may combine multiple data types and models for increased lead detection time. For example, the compressor observer 178 may calculate the rate of change of frequency (\dot{ω})=1/J(τₜ−τ_{c})), the rate of change of pressure (\dot{p}=α₀₁²/Vₚ(m−mₜ)), the rate of change of mass

$$( \dot{m} = \frac{{A}_{1}}{{L}_{c} ( {p}_{02} - p )} ) ,$$

or use the Luenberger Observer (e.g., {tilde over (\dot{x}=A\tilde{x}+Bu+L(y−C\tilde{x})) or a state observer (e.g., {tilde over (\dot{x}(k+1)=A\tilde{x} (k)+Bu(k); y(k)=C\tilde{x}(k)+Du(K)) to predict thermodynamic and mechanical outputs of the compressor 14. For the Luenberger Observer, u may represent the set of inputs (e.g., inputs to compressor system), {tilde over (\dot{x} may represent the estimated future state of the system (e.g., compressor system), \tilde{x} may represent the observed state of the system (e.g., compressor system), A, B, and C may represent matrices that may be derived by physical modeling of the system, such as a state based modeling, y represents outputs of the system (e.g., compressor system outputs) and L represents an observer gain. Likewise, for the state observer, u(k) may represent the set of inputs (e.g., inputs to compressor system) at time k, {tilde over (\dot{x}(k+1) may represent the estimated future state of the system (e.g., compressor system at time k+1), {tilde over (\dot{x}(k) may represent the observed state of the system (e.g., compressor system), A, B, C, and D may represent matrices that may be derived by physical modeling of the system, such as a state based modeling, y(k) represents outputs of the system (e.g., compressor system outputs).

Because the inlet sensors 62 and outlet sensors 64 may be placed at the inlet and outlet of the compressor 14, the actual, measured thermodynamic and mechanical outputs of the compressor (e.g., pressure, compressor speed, pressure, etc.) may then be compared with the outputs predicted using the system 160. The compressor observer 178 may compare these measured outputs with the predicted outputs. More specifically, the compressor observer 178 may compute the thermodynamic changes 180 using data from the hybrid model 176. The measured outputs 170 may also be used to calibrate the hybrid model 176 and to correct compressor observer 178 estimates, allowing the system to automatically calibrate the model 176 to the each turbine system unit 10. The deviation of predicted outputs 179 and the measured outputs 170 may be found using threshold based methods, model based methods, or methods that fuse multiple data types. Threshold-based methods may include calculating the deviation of identified frequencies and amplitudes from expected ones. Model-based methods may include calculating the deviation of model internal states from measured parameters. Multiple data type fusion may combine multiple hypothesis tests to enable a more robust hybrid model 176.

Next, mechanical changes and thermodynamic changes (e.g., 182 and 180) may be analyzed, as shown in surge detection block 184. Surge detection 184 may include a surge signature and probability distribution generator 186 and statistical change detection 188. The surge signature and probability distribution generator 186 may define surge signatures, or expected changes in thermodynamic and mechanical parameters, as a result of incipient surge and surge events. The signature may be a combination or collection of signals (e.g., mechanical and thermodynamic changes 182 and 180) so the signature may be a vector, rather than a line or curve. By defining signatures in this way, it may be possible to fuse data-driven statistical change detection algorithms with model-based detection algorithms to create a more robust stall detection scheme.

Statistical change detection (e.g., statistical modeling) 188 may augment physics-based models to predict changes in mechanical parameters, and may provide a probability that a change from a normal operating state has occurred using underlying signal probability distributions and measured data. Statistical methods to detect change may include Bayes' theorem, statistical outliers, likelihood models, and the like. For example, in some embodiments, a pressure model and/or matched filters (e.g., matched filters model) for the compressor 14 may be used to determine the dominant precursor frequency in the presence of noise in order to calculate the mechanical changes in the compressor 14. The pressure model may be a statistics-based model created via techniques such as data mining (e.g., k-means clustering, Bayesian classification, maximum likelihood estimation) linear and/or non-linear regression, and the like, to derive an expected pressure based on inputs such as compressor blade speed, compressor temperature, compressor fluid flow rate, compressor mass flow rate, and the like.

Next, model hypothesis testing may compare the signatures (e.g., the predicted changes in thermodynamic and mechanical parameters) with defined signatures (e.g., expected changes in thermodynamic and mechanical parameters as a result of stall and/or surge events) to determine whether stall is occurring or may occur, as shown in block 190. Model hypothesis testing, such as linear regression, non-linear regression, parametric regression, non-parametric regression, curve fitting, normalization, and heuristics, may be used to help generate the signature. The signature may be a vector that may be described as V[1, 2], where 1 and 2 comprise a pair selected from the following: temperature, pressure, fuel flow, gas flow, clearance (e.g., the measured space between rotating and stationary components), or any combination therein. In some embodiments, the signature may be a multi-dimensional vector, such as V[1, 2, . . . , N], where 1, 2 . . . , N is selected from the list of temperature, pressure, fuel flow, gas flow, clearance, or any combination thereof. The results of the model hypothesis testing enable the computation of surge probability. The surge probability derivation may determine whether the probability of compressor stall or surge is above a pre-defined threshold value (e.g., a probability limit or range). If the probability is above the threshold value, the process 160 may enable preventive actions before the unit trip (e.g., the disconnection of power to the unit 10) may be applied. For example, the process 160 may enable surge control line repositioning, valve opening/closing, inlet guide vane repositioning, or other measures that may prevent or stop the stall from occurring, continuing, or worsening. By providing a larger stall detection lead time, the hybrid model in the process 160 may enable preventive measures to be taken before the stall has occurred, and may reduce traditional surge margins, leading to improved operational range and efficiency. Furthermore, the hybrid model may reduce field time deployment resulting from stall.

Technical effects include hybrid models for deriving and acting on compressor surge. A system includes a controller having at least one processor configured to receive a measured input (e.g., measured inputs 162), execute a hybrid model 176, receive a measured output (e.g., measured mechanical and thermodynamic outputs 168 and 170), compare the measured input to the measured output to derive an error value, perform a signature analysis if the error value is beyond a range; and derive a probability of compressor stall based on the signature analysis. The hybrid model may include physics-based models, statistical models, artificial intelligence models, or a combination thereof. The hybrid model may enable larger stall lead detection times in the compressor 14, smaller false positive and negative detection rates, and reduced traditional stall margins, leading to improved performance of the gas turbine engine 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an industrial controller having at least one processor configured to:
receive a measured input from a turbomachinery having a compressor;
execute a hybrid model of the compressor;
receive a measured output;
compare the measured input to the measured output to derive an error value;
perform a signature analysis if the error value is beyond a range; and
derive a probability of a compressor stall based on the signature analysis.

2. The system of claim 1, wherein the hybrid model comprises, a physics-based model, a statistical model, an artificial intelligence model, or a combination thereof.

3. The system of claim 2, wherein the physics-based model comprises a Moore-Greitzer compressor model, a Fink compressor model, a Botros compressor model, or a combination thereof.

4. The system of claim 2, wherein the statistical model comprises a compressor pressure model, matched filters, a precursor model, or a combination thereof.

5. The system of claim 1, comprising a sensor disposed in at least one of fuel nozzle, compressor discharge valve, compressor, combustor, fuel conduit, air inlet, and wherein the sensor transmits the measured input to the industrial controller.

6. The system of claim 1, wherein the signature analysis comprises comparing a first signature derived during compressor operations to a second signature previously derived as indicating stall.

7. The system of claim 6, wherein the first signature comprises a vector (V[value 1, value 2]) and value 1 and value 2 comprise temperature, pressure, fuel flow, air flow, clearance, fuel type, or a combination thereof.

8. The system of claim 7, wherein the vector comprises a multi-dimensional vector (V[value 1, value 2, . . . , value N) and value N comprises temperature, pressure, fuel flow, air flow, clearance, fuel type, or a combination thereof.

9. The system of claim 1, wherein the hybrid model comprises a compressor observer configured to provide an estimated state of the compressor, and wherein the compressor observer comprises a Luenberger observer, a state observer, or a combination thereof.

10. The system of claim 9, wherein the Luenberger observer is configured to apply an observer gain L.

11. A tangible non-transitory machine readable computer media comprising computer instructions configured to:
receive a measured input;
execute a hybrid model;
receive a measured output;
compare the measured input to the measured output to derive an error value;
perform a signature analysis if the error value is beyond a range; and
derive a probability of compressor stall based on the signature analysis.

12. The tangible non-transitory machine readable computer media of claim 11, wherein the hybrid model comprises a physics-based model, a statistical model, an artificial intelligence model, or a combination thereof.

13. The tangible non-transitory machine readable computer media of claim 11, wherein the signature analysis comprises comparing a first signature derived during compressor operations to a second signature previously derived as indicating stall.

14. The tangible non-transitory machine readable computer media of claim 13, wherein the first signature comprises a vector (V[value 1, value 2]) and value 1 and value 2 comprise temperature, pressure, fuel flow, air flow, clearance, fuel type, or a combination thereof.

15. The tangible non-transitory machine readable computer media of claim 11, wherein if the probability is greater than a threshold value, stall-prevention measures are implemented by a turbomachinery controller.

16. A method, comprising:
receiving a measured input based on compressor operations;
executing a hybrid model;
receiving a measured result of compressor operations;
comparing the measured input to the measured result to derive an error value;
performing a signature analysis if the error value is beyond a range; and
deriving a probability of compressor stall based on the signature analysis, wherein the hybrid model comprises a physics-based model and a statistical model.

17. The method of claim 16, comprising disposing a sensor in at least one of the fuel nozzle, the compressor discharge valve, compressor, combustor, fuel conduit, air inlet, and wherein the sensor transmits the measured input or the measured result.

18. The method of claim 16, wherein the hybrid model comprises a physics-based model, a statistical model, and artificial intelligence model, or a combination thereof.

19. The method of claim 16, wherein the signature analysis generates a signature, and the signature comprises a vector (V[value 1, value 2 . . . value N]) and value 1, value 2, and value N comprise temperature, pressure, fuel flow, air flow, clearance, fuel type or a combination thereof.

20. The method of claim 16, comprising comparing the probability to a threshold value, and implementing stall-prevention measures if the probability is greater than the threshold value.
